(19) United States
(12) Patent Application Publication
(10) Pub. No.: US 2026/0084352 A1
(43) Pub. Date: Mar. 26, 2026

(54) INJECTION MOLDING SYSTEM

(71) Applicant: SEIKO EPSON CORPORATION, Tokyo (JP)

(72) Inventors: Masayuki SAKAI, MATSUMOTO-SHI (JP); Kazuya ARAKI, SHIOJIRI-SHI (JP)

(21) Appl. No.: 19/335,289

(22) Filed: Sep. 22, 2025

(30) Foreign Application Priority Data
Sep. 25, 2024 (JP) 2024-165739

(51) Int. Cl. B29C 45/42; B29C 45/40

(52) U.S. Cl. CPC B29C 45/42; B29C 45/4005; B29C 2945/76795

(57) ABSTRACT

An injection molding system includes an injection molding apparatus to which a mold is attached, and an ejection apparatus that ejects a molded product from the mold in a mold open state in which the mold is open, wherein the injection molding apparatus is configured to enable an operator to eject the molded product from the mold at a predetermined work position, and the injection molding apparatus is disposed between the work position and the ejection apparatus.

The present application is based on, and claims priority from JP Application Serial Number 2024-165739, filed September 25, 2024, the disclosure of which is hereby incorporated by reference herein in its entirety.

### BACKGROUND

### 1. Technical Field

The present disclosure relates to an injection molding system.

### 2. Related Art

In an injection molding system disclosed in JP-A-2016-203484, an ejection apparatus for ejecting a molded product is disposed vertically above a molding machine. In an injection molding system disclosed in JP-A-2016-83823, the ejection apparatus is disposed vertically below the molding machine.

JP-A-2016-203484 and JP-A-2016-83823 are examples of the related art.

When the ejection apparatus for ejecting a molded product is disposed vertically above the molding machine, the device becomes larger in the vertical directions. When the ejection apparatus is disposed vertically below the molding machine, it is hard to place another device such as a control device vertically below the molding machine, and a space for separately disposing the other device is required. Therefore, a technique to reduce the size of the entire injection molding system is desired.

### SUMMARY

According to a first aspect of the present disclosure, an injection molding system is provided. The injection molding system includes an injection molding apparatus to which a mold is attached, and an ejection apparatus that ejects a molded product from the mold in a mold open state in which the mold is open, wherein the injection molding apparatus is configured to enable an operator to eject the molded product from the mold at a predetermined work position, and the injection molding apparatus is disposed between the work position and the ejection apparatus.

### BRIEF DESCRIPTION OF THE DRAWINGS

FIG. 1 is a plan view showing a system configuration of an injection molding system.

FIG. 2 is a perspective view of the injection molding system.

FIG. 3 is a perspective view showing a schematic configuration of an injection molding apparatus.

FIG. 4 is a cross-sectional view showing a schematic configuration of a material supply device.

FIG. 5 is a perspective view showing a schematic configuration of a flat screw.

FIG. 6 is a schematic plan view of a barrel.

FIG. 7 is a side view of the injection molding apparatus viewed from a side of an ejection apparatus along a +X direction.

FIG. 8 is a perspective view of the ejection apparatus.

FIG. 9 is a perspective view of a rear side of an end effector.

FIG. 10 shows a production mode to which the injection molding system is applied.

FIG. 11 shows a line production mode.

FIG. 12 shows a cell production mode.

FIG. 13 is a process chart showing a teaching procedure of a molded product ejection operation.

FIG. 14 shows an example of a menu screen.

FIG. 15 shows an example of a direct teaching guide screen.

FIG. 16 shows an example of a position fine adjustment guide screen.

FIG. 17 shows an example of an offset value input guide screen.

FIG. 18 shows relationships between a taught position of the end effector and an offset value.

FIG. 19 shows an example of a taught position movement confirmation guide screen.

FIG. 20 shows an example of a velocity/acceleration setting guide screen.

### DESCRIPTION OF EMBODIMENTS

### A. First Embodiment:

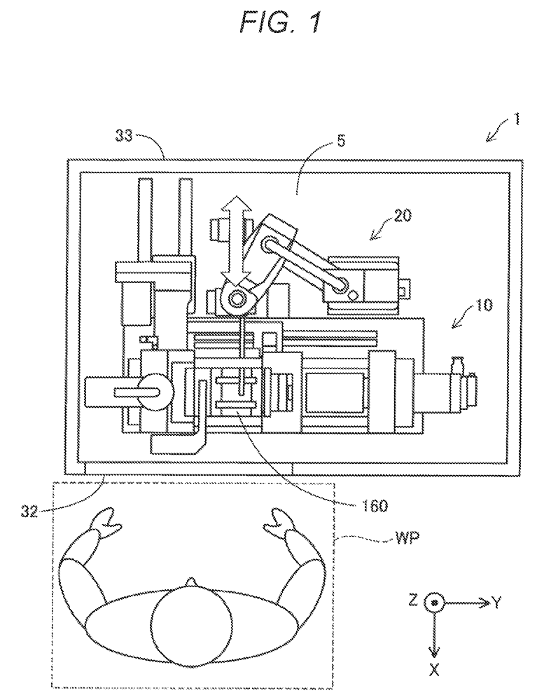

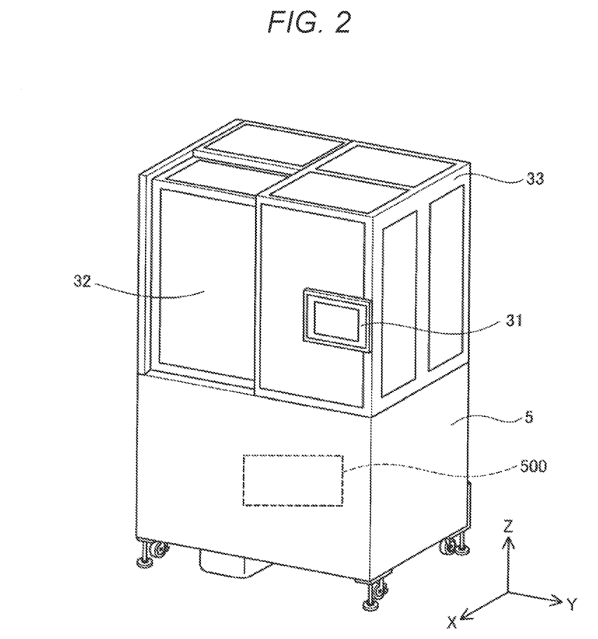

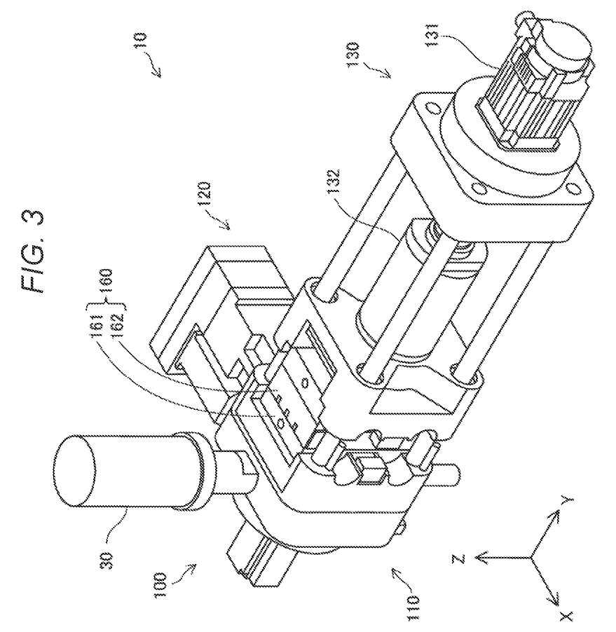

FIG. 1 is a plan view showing a system configuration of an injection molding system 1. FIG. 2 is a perspective view of the injection molding system 1. In FIG. 1 and FIG. 2, arrows indicating X, Y, and Z directions orthogonal to one another are shown. The X directions and the Y directions are directions parallel to a horizontal plane, and the Z directions are directions along a vertical direction. X, Y, and Z directions shown in FIG. 3 and the subsequent drawings correspond to the X, Y, and Z directions shown in FIG. 1 and FIG. 2. In the following description, to specify directions, both positive and negative signs are used in the description of the directions, where "+" refers to a positive direction that is a direction indicated by an arrow, and "-" refers to a negative direction that is an opposite direction to the direction indicated by the arrow. The +Z direction is a vertically upward direction, and the -Z direction is a vertically downward direction. The vertically upward direction is a direction opposite to the vertically downward direction. The vertically downward direction is a direction in which gravity acts, and is also referred to as a gravity direction. Hereinafter, the vertically upward direction is simply referred to as "above", and the vertically downward direction is simply referred to as "below".

As shown in FIG. 1, the injection molding system 1 includes an injection molding apparatus 10 to which a mold 160 is attached, and an ejection apparatus 20. The ejection apparatus 20 is an apparatus that ejects a molded product from the mold 160 in a mold open state in which the mold 160 is open. In the present embodiment, the mold 160 opens and closes along the Y directions. The injection molding apparatus 10 and the ejection apparatus 20 are disposed on a base 5. As shown in FIG. 2, a rectangular parallelepiped cover 33 having transparent windows is disposed on the base 5. The injection molding apparatus 10 and the ejection apparatus 20 are covered with the cover 33. A control unit 500 for controlling the injection molding apparatus 10 and the ejection apparatus 20 is disposed in the base 5. An operation panel 31 coupled to the control unit 500 is fixed to the cover 33. In the present embodiment, the operation panel 31 includes a touch panel. The cover 33 includes an openable and closable door 32.

FIG. 1 shows a predetermined work position WP. In the present embodiment, the work position WP is a position facing the openable and closable door 32. That is, in the present embodiment, the door 32 is disposed between the work position WP and the injection molding apparatus 10. The injection molding apparatus 10 is configured such that an operator can eject the molded product from the mold 160 through the door 32 at the work position WP. The configuration in which the molded product can be ejected from the mold 160 refers to a configuration of the injection molding apparatus 10 in which a shield such as a wire or a pipe that blocks the operator's hand from accessing the mold 160 in the mold open state.

The injection molding apparatus 10 is disposed between the work position WP and the ejection apparatus 20. That is, the ejection apparatus 20 is disposed at the opposite side to the work position WP with respect to the injection molding apparatus 10. The ejection apparatus 20, the injection molding apparatus 10, and the work position WP are arranged in this order in the X directions intersecting the Y directions in which the mold 160 opens and closes. According to the arrangement, either the ejection apparatus 20 or the operator can eject the molded product from the mold 160 when the mold 160 is opened. In the present embodiment, the injection molding apparatus 10 and the ejection apparatus 20 are covered with the cover 33, but the cover 33 may be omitted.

FIG. 3 is a perspective view showing a schematic configuration of the injection molding apparatus 10. The injection molding apparatus 10 includes a material supply device 100 and a mold clamping device 130. The injection molding apparatus 10 injects a plasticized material generated by the material supply device 100 into the mold 160 to mold a molded product. Operations of the material supply device 100 and the mold clamping device 130 are controlled by the control unit 500 illustrated in FIG. 2. The control unit 500 is implemented as a computer including a CPU and a memory, and controls each unit of the injection molding apparatus 10 by the CPU executing a program stored in the memory. The control unit 500 may be implemented by a circuit.

The mold 160 of a metal is mounted on the mold clamping device 130. The mold 160 is not limited to a metal, but may be a resin or ceramic. The mold 160 of a metal is referred to as a metal mold. The mold 160 includes a fixed-side plate 161 and a movable-side plate 162. A cavity for molding a molded product is formed between the fixed-side plate 161 and the movable-side plate 162.

The mold clamping device 130 has a function of opening and closing the fixed-side plate 161 and the movable-side plate 162. A state in which the fixed-side plate 161 and the movable-side plate 162 are separated from each other is referred to as the mold open state. Under the control of the control unit 500, the mold clamping device 130 drives a mold drive unit 131 including a motor to rotate a ball screw 132 and move the movable-side plate 162 coupled to the ball screw 132 with respect to the fixed-side plate 161 and opens and closes the mold 160. A direction in which the movable-side plate 162 moves away from the fixed-side plate 161 is referred to as a mold opening direction, and is the +Y direction in the present embodiment. Reversely, a direction in which the movable-side plate 162 moves closer to the fixed-side plate 161 is referred to as a mold clamping direction, and is the -Y direction in the present embodiment.

The material supply device 100 is coupled to a hopper 30 into which a material for the molded product is placed. As the material for the molded product, a thermoplastic resin formed in pellet form is used. Examples of the thermoplastic resin include ABS (acrylonitrile butadiene styrene), PC (polycarbonate), POM (polyacetal), PP (polypropylene), and PBT (polybutylene terephthalate). The material for the molded product may contain metal or ceramic in addition to the thermoplastic resin. Supply of the material to the material supply device 100 is not limited to being performed via the hopper 30, but may be performed via, for example, a tube in which the material is pressure-fed.

The material supply device 100 plasticizes at least a part of the material supplied from the hopper 30 to produce a plasticized material, and injects the produced plasticized material into the cavity defined between the fixed-side plate 161 and the movable-side plate 162. In the present specification, "plasticizing" has a concept including melting and refers to changing from a solid state to a state having fluidity. Specifically, in a case of a material in which glass transition occurs, plasticizing refers to setting the temperature of the material to the glass transition point or higher. In a case of a material in which glass transition does not occur, plasticizing refers to setting the temperature of the material to the melting point or higher.

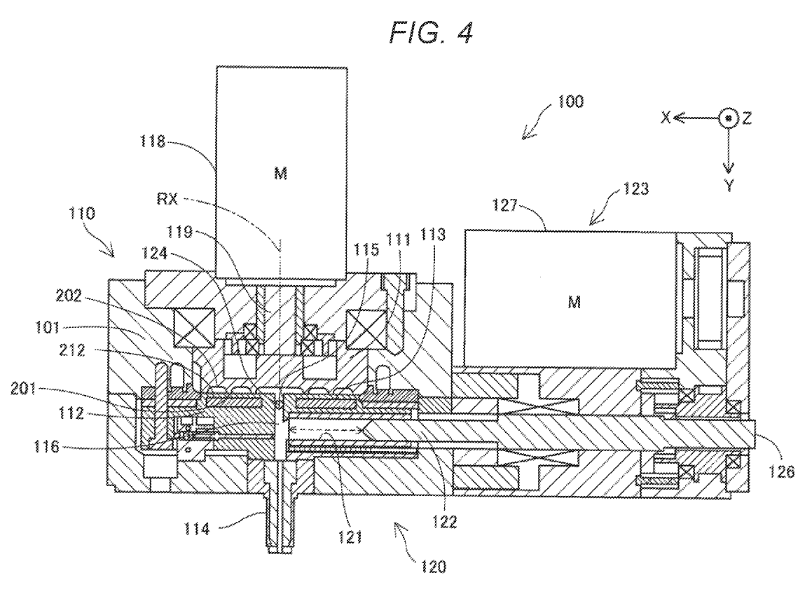

FIG. 4 is a cross-sectional view showing a schematic configuration of the material supply device 100. The material supply device 100 includes a plasticizing unit 110 that plasticizes at least a part of the material to produce a plasticized material, a nozzle 114 that injects the plasticized material, and an injection unit 120 that communicates with the nozzle 114.

The plasticizing unit 110 includes a flat screw 111, a barrel 112, and a heater 113 as a heating unit.

The flat screw 111 is housed in a housing portion 101. The flat screw 111 is referred to as a rotor or simply as a screw. The flat screw 111 is rotated by a motor 118 in the housing portion 101 around a drive shaft 119 of the motor 118. A center axis RX serving as a rotation center of the flat screw 111 coincides with a center of the drive shaft 119 of the motor 118 in an XZ plane. In the present embodiment, axial directions of the drive shaft 119 and the center axis RX are along the Y directions. The rotation of the flat screw 111 by the motor 118 is controlled by the control unit 500. The flat screw 111 may be driven by the motor 118 via a reducer.

A communication hole 115 is formed at a center of the barrel 112. The communication hole 115 communicates with a flow path 116. A cylinder 121 to be described later and the nozzle 114 are coupled to the flow path 116. In the flow path 116, a check valve 124 is provided upstream of the cylinder 121. The check valve 124 prevents a backflow of the plasticized material from the cylinder 121 toward the flat screw 111.

The heater 113 heats the barrel 112. The heating by the heater 113 is controlled by the control unit 500.

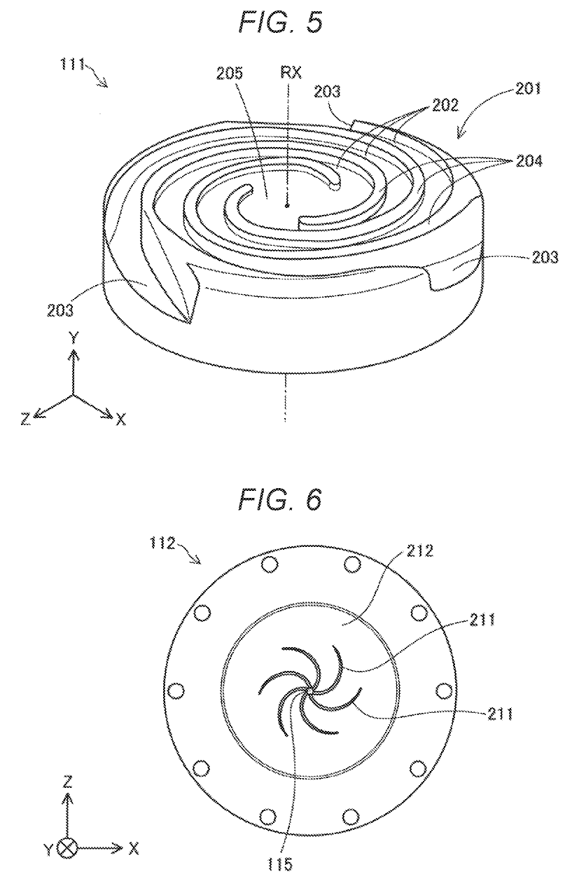

FIG. 5 is a perspective view showing a schematic configuration of the flat screw 111. The flat screw 111 has a substantially cylindrical shape in which a length in a direction along the center axis RX is smaller than a length in a direction perpendicular to the center axis RX. In a grooved surface 201 of the flat screw 111 facing the barrel 112, vortex-shaped grooves 202 are formed around a center portion 205. The groove 202 communicates with a material inlet 203 formed in a side surface of the flat screw 111. The material supplied from the hopper 30 is supplied to the grooves 202 via the material inlets 203. The grooves 202 are formed by being separated by protruding portions 204. FIG. 5 illustrates an example in which the three grooves 202 are formed. However, the number of grooves 202 may be one, two, or more. The grooves 202 do not necessarily have vortex shapes, but may have spiral shapes or shapes of involute curves, or may have shapes extending arcuately from the center portion 205 toward the outer circumference.

FIG. 6 is a schematic plan view of the barrel 112. The barrel 112 has an opposite surface 212 facing the grooved surface 201 of the flat screw 111. The communication hole 115 communicating with the flow path 116 is formed at a center of the opposite surface 212. In the opposite surface 212, a plurality of guide grooves 211 coupled to the communication hole 115 and extending in a shape of a vortex from the communication hole 115 toward the outer circumference are formed. The guide grooves 211 are not necessarily provided in the barrel 112. Further, the guide grooves 211 are not necessarily coupled to the communication hole 115.

The material supplied to the grooves 202 of the flat screw 111 flows along the grooves 202 and the guide grooves 211 due to rotation of the flat screw 111 while being plasticized between the flat screw 111 and the barrel 112 by the rotation of the flat screw 111 and heating by the heater 113, and is guided to the center portion 205 of the flat screw 111. The material flowing into the center portion 205 flows out into the flow path 116 through the communication hole 115 provided at the center of the barrel 112.

As shown in FIG. 4, the injection unit 120 includes the cylinder 121 that communicates with the nozzle 114 and is coupled to the flow path 116 through which the plasticized material flows, a plunger 122 that moves inside the cylinder 121, and a plunger drive unit 123. The cylinder 121 has a substantially cylindrical shape. The cylinder 121 is also called a sleeve. The plunger 122 has a substantially columnar shape. The plunger drive unit 123 includes a ball screw 126 that moves the plunger 122 along a longitudinal direction of the plunger 122, and a motor 127 that drives the ball screw 126. In the present embodiment, when the ball screw 126 is driven by the motor 127, the plunger 122 coupled to the ball screw 126 moves forward or rearward. "Forward" refers to a direction in which the plunger 122 moves closer to the flow path 116. "Rearward" refers to a direction in which the plunger 122 moves away from the flow path 116.

In the injection unit 120, the plunger drive unit 123 is controlled by the control unit 500, thereby performing a suction operation and a feeding operation. The suction operation is an operation of suctioning the plasticized material from the flow path 116 into the cylinder 121 by moving the plunger 122 rearward. The feeding operation is an operation of feeding the plasticized material suctioned into the cylinder 121 to the nozzle 114 by moving the plunger 122 forward. The control unit 500 controls an injection amount, an injection velocity, and injection pressure of the plasticized material from the nozzle 114 by adjusting a movement amount and a movement velocity of the plunger 122 in the suction operation and the feeding operation. The suction operation is also referred to as a metering operation.

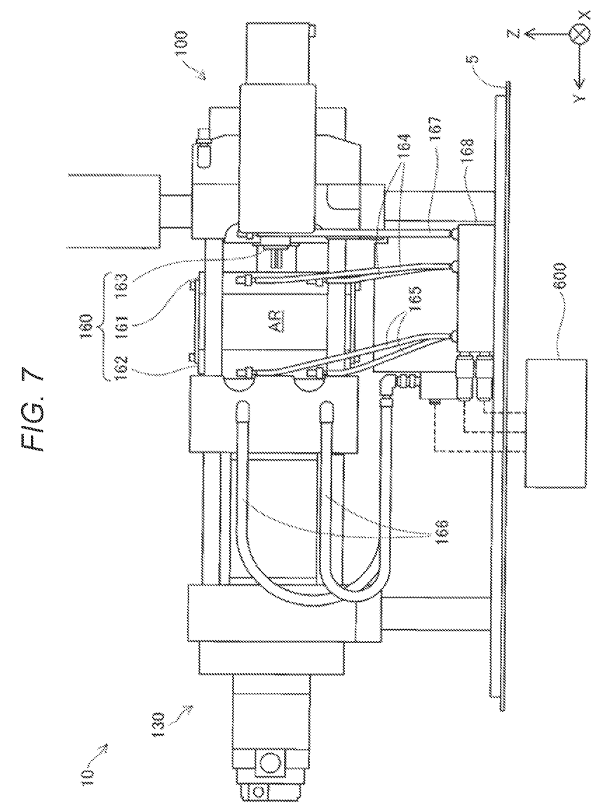

FIG. 7 is a side view of the injection molding apparatus 10 viewed from the ejection apparatus 20 side along the +X direction. FIG. 7 shows the mold 160 in the mold open state. First tubes 164 for supplying a fluid into the fixed-side plate 161 are coupled to the fixed-side plate 161. Second tubes 165 for supplying a fluid into the movable-side plate 162 are coupled to the movable-side plate 162. The first tubes 164 and the second tubes 165 are respectively coupled to the side surfaces of the fixed-side plate 161 and the movable-side plate 162 at the ejection apparatus 20 side. A flow path through which a fluid flows is formed inside each of the fixed-side plate 161 and the movable-side plate 162. The fluids supplied to the fixed-side plate 161 and the movable-side plate 162 are fluids for adjusting the temperatures of the fixed-side plate 161 and the movable-side plate 162.

The first tubes 164 and the second tubes 165 are displaced as the fixed-side plate 161 and the movable-side plate 162 move. Therefore, the first tubes 164 and the second tubes 165 are respectively formed using flexible resins. As the resin having flexibility, for example, PTFE (polytetrafluoroethylene) is used. The first tubes 164 and the second tubes 165 are coupled to a temperature controller 600 via a distributor 168 provided on the base 5. The temperature controller 600 is disposed, for example, in the base 5. The distributor 168 distributes the fluids supplied from the temperature controller 600 to the first tubes 164 and the second tubes 165. In the example shown in FIG. 7, first pipes 166 for cooling are also coupled to the mold clamping device 130 that drives the mold 160. A second pipe 167 for cooling is also coupled to the plasticizing unit 110. The first pipe 166 has a structure in which a flexible resin tube is covered with a metal flexible tube. The first pipe 166 is configured to be displaceable following the operation of the mold clamping device 130 by being bent in a U shape. The second pipe 167 is formed using a flexible resin similarly to the first tubes 164 and the second tubes 165.

The mold 160 shown in FIG. 7 includes a runner stripper plate 163 in addition to the fixed-side plate 161 and the movable-side plate 162. That is, the mold 160 is a three-plate mold. The mold 160 may be a two-plate mold without including the runner stripper plate 163.

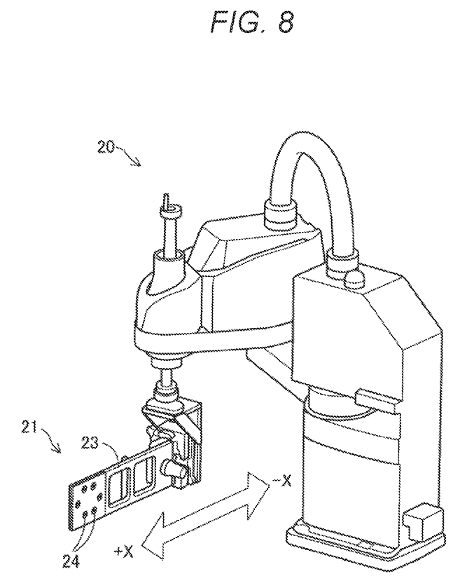

At opening of the mold, when the movable-side plate 162 moves with respect to the fixed-side plate 161, a space is generated between the fixed-side plate 161 and the movable-side plate 162. This space is referred to as an ejection region AR. After the mold is opened, the end effector 21 shown in FIG. 8 is inserted into the ejection region AR by the ejection apparatus 20, whereby the molded product is ejected in the ejection region AR. In the mold open state, the first tubes 164 are coupled to the fixed-side plate 161 so that the end effector 21 does not interfere with the first tubes 164. Further, in the mold open state, the second tubes 165 are coupled to the movable-side plate 162 so that the end effector 21 does not interfere with the second tubes 165. When the ejection region AR in the mold open state is viewed from the ejection apparatus 20 side, the first tubes 164 and the second tubes 165 do not overlap the ejection region AR. In the present embodiment, the lengths of the first tubes 164 are determined such that the first tubes 164 are linearly coupled to the distributor 168 and the fixed-side plate 161 in the mold open state. Further, the lengths of the second tubes 165 are determined such that the second tubes 165 are linearly coupled to the distributor 168 and the movable-side plate 162 in the mold open state. The first tubes 164 and the second tubes 165 respectively extend substantially along the vertical direction. Rising angles of the first tubes 164 and the second tubes 165 from the horizontal direction are, for example, within a range from 70 degrees to 90 degrees in the mold open state.

FIG. 8 is a perspective view of the ejection apparatus 20. The ejection apparatus 20 in the present embodiment includes a robot. As the robot, for example, a horizontal articulated robot is used. The end effector 21 is provided at the distal end of the robot arm provided in the ejection apparatus 20. The end effector 21 includes a flat plate-shaped main body 23 having a surface along the vertical direction and suction portions 24 for vacuum-suction of the molded product. The suction portions 24 are disposed at the distal end of the surface of the main body 23 so as to face the horizontal direction. In the present embodiment, a plurality of the suction portions 24 are disposed in the main body 23. When the mold 160 is opened, the ejection apparatus 20 inserts the end effector 21 into the ejection region AR such that the suction portions 24 face the movable-side plate 162. The insertion direction of the end effector 21 into the ejection region AR is the horizontal direction and the direction perpendicular to the mold opening direction, and is the +X direction in the present embodiment. The end effector 21 is attached to the ejection apparatus 20 via an attachment/detachment mechanism. As the attachment/detachment mechanism, a one-touch attachment/detachment mechanism detachable without using a tool can be used.

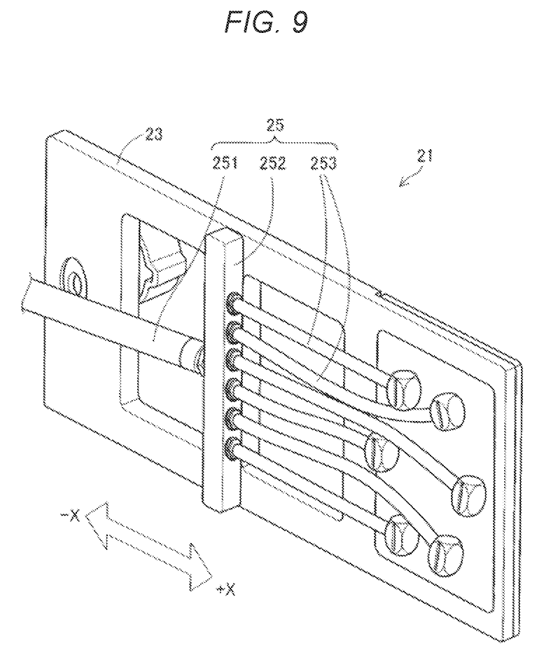

FIG. 9 is a perspective view of a rear side of the end effector 21. A pipe 25 coupled to the suction portions 24 is disposed at the rear side of the main body 23. The pipe 25 includes one main pipe 251 coupled to a vacuum device, a branch portion 252 for branching the main pipe 251, and a plurality of branch pipes 253 coupled to the branch portion 252. Each branch pipe 253 is coupled to the corresponding suction portion 24. The main pipe 251 and the branch pipes 253 are respectively disposed along the +X direction. That is, the pipe 25 is disposed along the direction in which the end effector 21 is inserted into the ejection region AR as a whole.

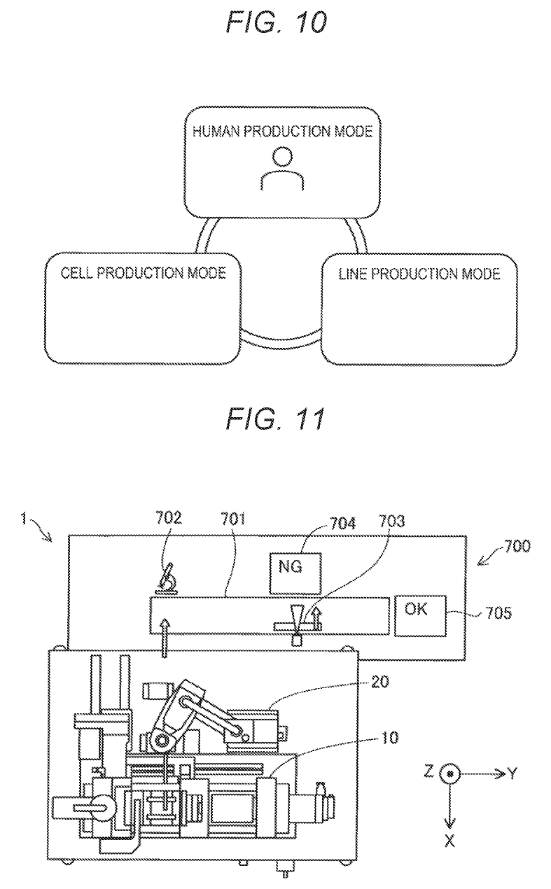

FIG. 10 shows a production mode to which the injection molding system 1 is applied. The injection molding apparatus 10 is operated in one production mode selected from a human production mode, a line production mode, and a cell production mode. The human production mode is also referred to as a first production mode. The line production mode is also referred to as a second production mode. The cell production mode is also referred to as a third production mode. The operator can switch these production modes using the operation panel 31.

The human production mode is a mode in which the operator ejects the molded product at the work position WP without operating the ejection apparatus 20 in FIG. 1. For example, when producing a prototype, the operator switches the production mode from the line production mode or the cell production mode to the human production mode. The control unit 500 operates the ejection apparatus 20 when the line production mode or the cell production mode is selected, and stops the operation of the ejection apparatus 20 when the human production mode is selected. In the human production mode, the control unit 500 stops a molding cycle at each time when the mold is opened. While the molding cycle is stopped, the operator ejects the molded product from the mold 160 in the mold open state at the work position WP. When detecting that the operator performs a predetermined operation using the operation panel 31 after the mold is opened, the control unit 500 executes the next molding cycle.

FIG. 11 shows the line production mode. The line production mode is a mode in which the ejection apparatus 20 delivers the ejected molded product to a downstream process line. In FIG. 11, an inspection line 700 is shown as the downstream process line. The inspection line 700 includes a belt conveyor 701, an inspection device 702, and a sorting device 703. The molded product is transported onto the belt conveyor 701 by the ejection apparatus 20. The molded product transported onto the belt conveyor 701 is inspected by the inspection device 702. The inspection device 702 includes, for example, a camera, and performs visual inspection of the molded product by the camera. The molded product for which the inspection has been completed is conveyed to the sorting device 703 by the belt conveyor 701. The sorting device 703 pushes out the molded product that has failed as a result of the inspection from the belt conveyor 701 to a failed product box 704 for holding the failed products. The passed molded product is conveyed without being sorted by the belt conveyor 701 to a passed product box 705 for holding the passed products.

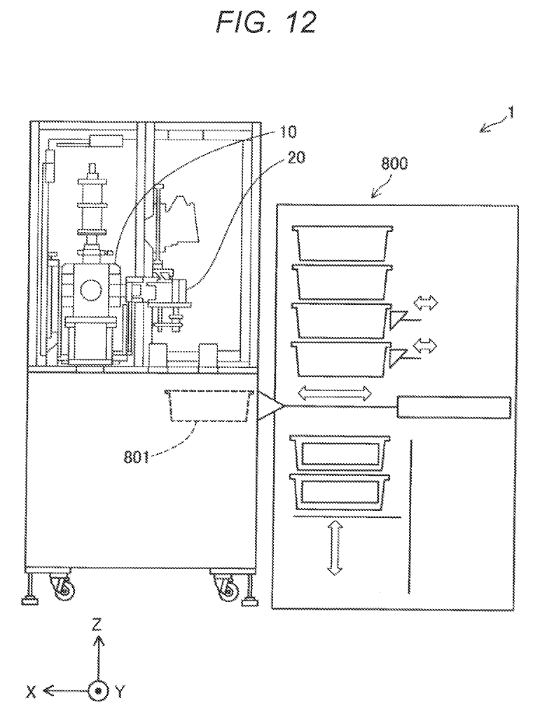

FIG. 12 shows the cell production mode. The cell production mode is a mode in which the ejection apparatus 20 puts the molded product ejected from the injection molding apparatus 10 in a carry-out tray 801. The injection molding system 1 includes a stacking mechanism 800. The stacking mechanism 800 has a function of moving the carry-out tray 801 for holding the molded products in the horizontal directions and the vertical directions. When a predetermined number of molded products are put in the carry-out tray 801 in the base 5 by the ejection apparatus 20, the stacking mechanism 800 takes out the carry-out tray 801 from the base 5 and moves the carry-out tray downward in the stacking mechanism 800. Then, the new carry-out tray 801 is lowered from above and inserted into the base 5.

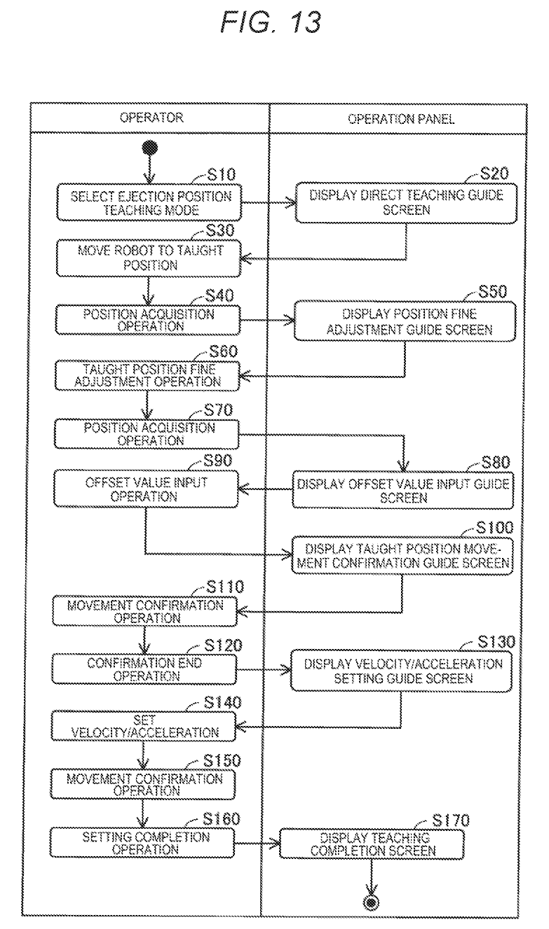

FIG. 13 is a process chart showing a teaching procedure of a molded product ejection operation for the ejection apparatus 20. In step S10, the operator selects an ejection position teaching mode using the menu screen displayed on the operation panel 31.

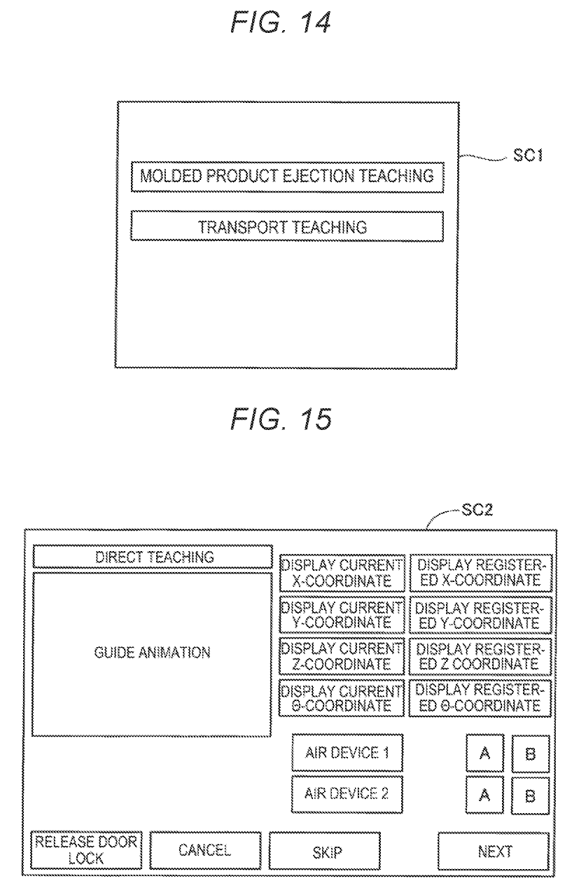

FIG. 14 shows an example of a menu screen SC1 displayed on the operation panel 31 by the control unit 500. When the operator selects "molded product ejection teaching" on the menu screen SC1, the ejection position teaching mode is selected. When the operator selects "transport teaching", a mode for teaching a transport operation after the molded product is ejected is selected.

FIG. 15 shows an example of a direct teaching guide screen SC2 displayed on the operation panel 31. When the ejection position teaching mode is selected in step S10, the control unit 500 displays the direct teaching guide screen SC2 in step S20. The direct teaching refers to teaching by the operator directly moving the ejection apparatus 20 by the operator's hand to teach the position.

In step S30, the operator directly moves the ejection apparatus 20 with the operator's hand to move the end effector 21 to a taught position. In the present embodiment, the taught position is a position in the ejection region AR between the movable-side plate 162 and the fixed-side plate 161, in which the suction portions 24 of the end effector 21 face the molded product in the cavity. A direct teaching method is displayed on the direct teaching guide screen SC2 by animation or a moving image. The current position of the end effector 21 is displayed in real time on the direct teaching guide screen SC2.

In step S40, the operator presses a predetermined button on the operation panel 31 to cause the control unit 500 to execute a position acquisition operation. The position acquisition operation refers to acquiring the current position of the end effector 21 from each encoder provided in the ejection apparatus 20.

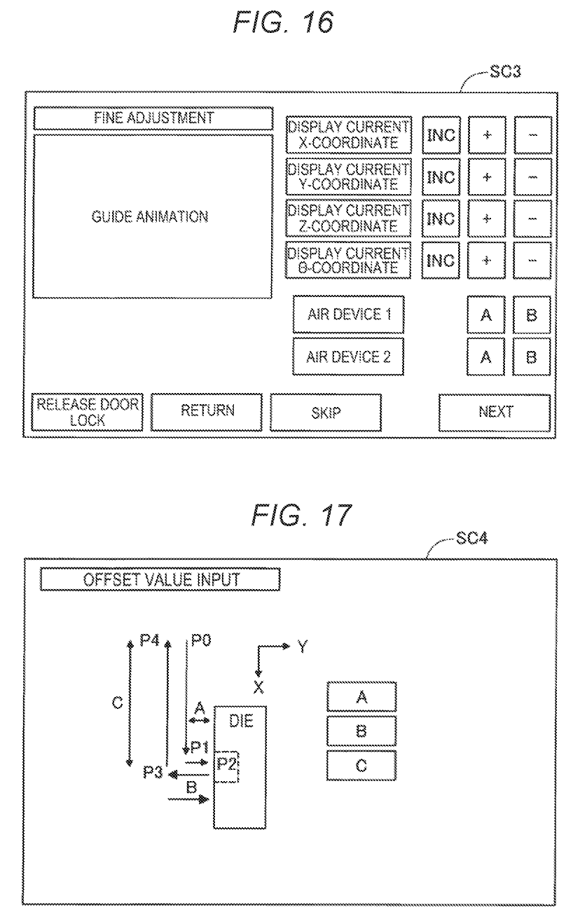

FIG. 16 shows an example of a position fine adjustment guide screen SC3 displayed on the operation panel 31. After the position acquisition operation is executed in step S40, the control unit 500 displays the position fine adjustment guide screen SC3 on the operation panel 31 in step S50.

In step S60, the operator performs fine adjustment of the position of the end effector 21 by using a position adjustment button in the position fine adjustment guide screen SC3 displayed on the operation panel 31. On the position fine adjustment guide screen SC3, a fine adjustment method is displayed by animation or a moving image.

In step S70, the operator presses a predetermined button on the operation panel 31 to cause the control unit 500 to execute the position acquisition operation for the position after the fine adjustment.

FIG. 17 shows an example of an offset value input guide screen SC4 displayed on the operation panel 31. After the position acquisition operation is executed in step S70, the control unit 500 displays the offset value input guide screen SC4 on the operation panel 31 in step S80. In step S90, the operator inputs a value A, a value B, and a value C to the offset value input guide screen SC4. The value A is an offset value representing a movement amount of the end effector 21 in the +Y direction for bringing the suction portions 24 of the end effector 21 into contact with the molded product in the cavity. The value B is an offset value representing a movement amount by which the end effector 21 is moved in the -Y direction after the molded product is suctioned. The value C is an offset value representing a movement amount in the +X direction for causing the end effector 21 to enter the ejection region AR for ejecting the molded product, and is also an offset value representing a movement amount in the -X direction of the end effector 21 for causing the molded product to exit the ejection region AR. With these values as values C1 and C2, the offset values representing the movement amounts in the X directions may be individually set for entry and exit.

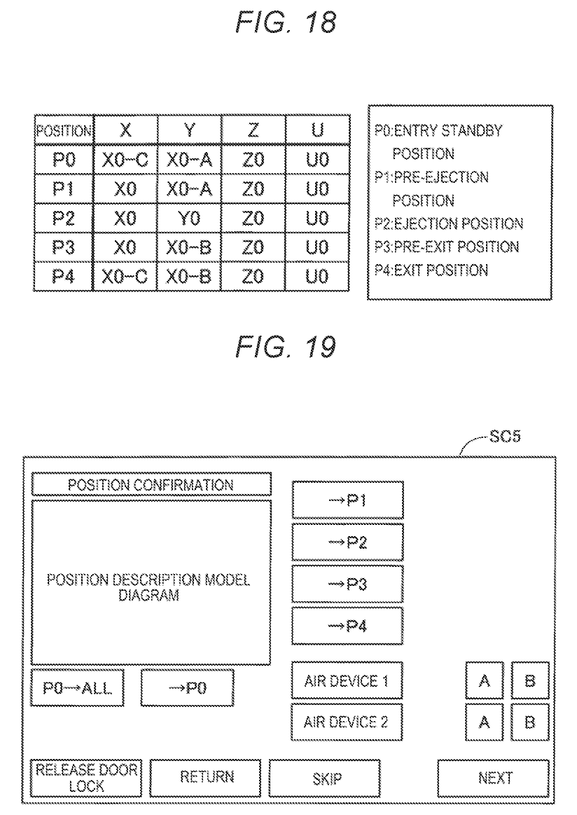

FIG. 18 shows a relationship between the taught position of the end effector 21 and the offset value. A position P2 shown in FIG. 17 and FIG. 18 corresponds to the taught position described above. An entry standby position P0, a pre-ejection position P1, the ejection position P2, a pre-exit position P3, and an exit position P4 of the end effector 21 are determined by the position P2 and the values A, B, and C input in step S90. In the present embodiment, since the position of the end effector 21 in the Z directions and the insertion angle of the end effector 21 with respect to the ejection region AR are fixed values, teaching of these values is unnecessary.

FIG. 19 shows an example of a taught position movement confirmation guide screen SC5 displayed on the operation panel 31. As described above, when each position of the end effector 21 is determined, the control unit 500 causes the operation panel 31 to display the taught position movement confirmation guide screen SC5 in step S100. In step S110, the operator performs a movement confirmation operation using each button displayed on the taught position movement confirmation guide screen SC5. When each button is operated on the taught position movement confirmation guide screen SC5, the control unit 500 drives the ejection apparatus 20 to actually move the position of the end effector 21 to the positions P0 to P4 designated by the worker. The taught position movement confirmation guide screen SC5 displays description of each position of the end effector 21. In the present embodiment, when the movement confirmation operation is executed in step S110, the control unit 500 operates the ejection apparatus 20 in a low power mode. The low power mode is a mode in which the ejection apparatus 20 is operated with power lower than power applied in the actual molding cycle. By operating the ejection apparatus 20 in the low power mode, even when the ejection apparatus 20 comes into contact with the injection molding apparatus 10 or the like due to an error in the taught position or the values A, B, and C, damage on each device can be suppressed.

When the movement confirmation to each position is completed, the operator operates the operation panel 31 to perform a confirmation end operation in step S120.

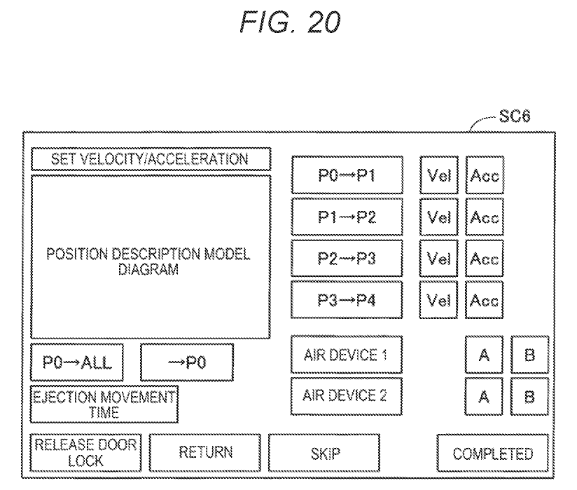

FIG. 20 shows an example of a velocity/acceleration setting guide screen SC6 displayed on the operation panel 31. In step S130, when the confirmation end operation is performed, the control unit 500 displays the velocity/acceleration setting guide screen SC6 on the operation panel 31. In step S140, the operator performs settings of the movement velocity and the acceleration of the end effector 21 between the positions on the velocity/acceleration setting guide screen SC6. The velocity/acceleration setting guide screen SC6 displays description of each position of the end effector 21. When the settings of the movement velocity and the acceleration are completed, the operator performs the movement confirmation operation again by pressing a predetermined button on the operation panel 31 in step S150. In the present embodiment, when the movement confirmation operation is executed in step S150, the control unit 500 operates the ejection apparatus 20 in a normal power mode. The normal power mode is a mode in which the same power as that in the molding cycle is applied to the ejection apparatus 20. When the movement confirmation is completed, the operator performs a setting completion operation by pressing a predetermined button on the operation panel 31 in step S160. When the setting completion operation is performed, the control unit 500 displays a teaching completion screen indicating that the teaching is completed on the operation panel 31 in step S170.

When the operator selects the transport teaching instead of the molded product ejection teaching on the menu screen SC1 illustrated in FIG. 14, the operator can teach the transport operation after the ejection of the molded product by omitting steps S80 and S90 described above.

In the injection molding system 1 of the first embodiment described above, the injection molding apparatus 10 is disposed between the work position WP of the operator and the ejection apparatus 20. Therefore, since the injection molding apparatus 10 and the ejection apparatus 20 can be efficiently disposed by disposing the injection molding apparatus 10 and the ejection apparatus 20 adjacent to each other in the horizontal directions, the injection molding system 1 can be downsized as compared with a case where the ejection apparatus 20 is disposed vertically above or vertically below the injection molding apparatus 10.

Further, in the present embodiment, since the injection molding apparatus 10 is disposed between the work position WP of the operator and the ejection apparatus 20, the operator can directly access the mold 160 of the injection molding apparatus 10 without interference from the ejection apparatus 20. Therefore, for example, when molding a prototype or checking the operation of the injection molding apparatus 10, the ejection of the molded product by the ejection apparatus 20 is stopped, and the molded product can be manually ejected from the mold 160.

In the embodiment, the first tubes 164 are coupled to the fixed-side plate 161 so that the end effector 21 does not interfere with the first tubes 164 in the mold open state, and the second tubes 165 are coupled to the movable-side plate 162 so that the end effector 21 does not interfere with the second tubes 165 in the mold open state. Therefore, when the end effector 21 is inserted between the fixed-side plate 161 and the movable-side plate 162, the possibility that the end effector 21 interferes with the tubes for adjusting the temperature of the mold 160 can be reduced. The temperature control here is mainly temperature control by heating in normal operation, but includes temperature control by cooling when necessary as a molding condition.

Further, in the present embodiment, the first tubes 164 and the second tubes 165 are disposed not on the side surface at the work position WP side but on the side surface at the ejection apparatus 20 side in the injection molding apparatus 10. Therefore, when the operator ejects the molded product, the operator's hand or the molded product can be prevented from interfering with the first tubes 164 or the second tubes 165.

In the present embodiment, the first tubes 164 and the second tubes 165 do not overlap the ejection region AR when the ejection region AR between the fixed-side plate 161 and the movable-side plate 162 in the mold open state is viewed from the ejection apparatus 20 side. Therefore, the possibility that the end effector 21 interferes with the first tubes 164 or the second tubes 165 can be further reduced.

In the present embodiment, the pipe 25 coupled to the suction portions 24 of the end effector 21 is disposed along the direction in which the end effector 21 is inserted between the fixed-side plate 161 and the movable-side plate 162. Therefore, since the thickness of the entire end effector 21 including the pipe 25 is suppressed, the possibility that the end effector 21 interferes with the first tubes 164 or the second tubes 165 can be further reduced.

In the present embodiment, the injection molding apparatus 10 is operated in the production mode selected from the human production mode, the line production mode, and the cell production mode. Therefore, the injection molding system 1 can be applied to various production sites.

In the present embodiment, the operation of the ejection apparatus 20 can be taught using the operation panel 31 provided in the injection molding system 1 without using an external device such as a teaching pendant. Therefore, the operator can easily teach the operation of the ejection apparatus 20. Further, in the present embodiment, since an animation or a moving image related to the teaching operation can be displayed on the operation panel 31, the operator can easily perform the teaching.

### B. Other Embodiments:

(B1) In the above embodiment, the injection molding apparatus 10 includes the flat screw 111 as the screw. In contrast, the injection molding apparatus 10 may include an in-line screw as the screw.

(B2) In the above embodiment, the first tubes 164 and the second tubes 165 are arranged so as not to overlap the ejection region AR when the ejection region AR in the mold open state is viewed from the ejection apparatus 20 side. In contrast, the first tubes 164 and the second tubes 165 may partially or entirely overlap the ejection region AR as long as the end effector 21 does not interfere with the first tubes 164 and the second tubes 165.

(B3) In the embodiment described above, the pipe 25 provided in the end effector 21 is disposed along the insertion direction of the end effector 21 into the ejection region AR. In contrast, the pipe 25 may be disposed in a direction perpendicular to the main body 23 or a direction intersecting the insertion direction into the ejection region AR as long as the end effector 21 does not interfere with the first tubes 164 and the second tubes 165.

(B4) In the above embodiment, the production mode of the injection molding apparatus 10 is selected from the human production mode, the line production mode, and the cell production mode. In contrast, the injection molding apparatus 10 may produce the molded product in a predetermined production mode.

### C. Other Configurations:

The present disclosure is not limited to the above-described embodiments, but may be implemented with various configurations without departing from the spirit and scope of the present disclosure. For example, technical features in the embodiments corresponding to technical features in the respective configurations described below can be replaced or combined as appropriate in order to solve a part or all of the above-described problems or in order to achieve a part or all of the above-described effects. The technical features can be deleted as appropriate unless described as essential technical features in the present specification.

1. According to a first aspect of the present disclosure, an injection molding system is provided. The injection molding system includes an injection molding apparatus to which a mold is attached, and an ejection apparatus that ejects a molded product from the mold in a mold open state in which the mold is open, wherein the injection molding apparatus is configured to enable an operator to eject the molded product from the mold at a predetermined work position, and the injection molding apparatus is disposed between the work position and the ejection apparatus. According to the configuration, the injection molding system can be downsized.

2. In the configuration described above, the mold may include a fixed-side plate and a movable-side plate, the mold open state may be a state in which the movable-side plate is separated from the fixed-side plate, a first tube that supplies a fluid into the fixed-side plate may be coupled to the fixed-side plate, a second tube that supplies a fluid into the movable-side plate may be coupled to the movable-side plate, the ejection apparatus may include an end effector inserted between the fixed-side plate and the movable-side plate in the mold open state, the first tube may be coupled to the fixed-side plate to prevent the end effector from interfering with the first tube in the mold open state, and the second tube may be coupled to the movable-side plate to prevent the end effector from interfering with the second tube in the mold open state. According to the configuration, when the end effector is inserted between the fixed-side plate and the movable-side plate, the possibility that the end effector interferes with the tubes can be reduced.

3. In the configuration described above, when a region between the fixed-side plate and the movable-side plate in the mold open state is viewed from a side of the ejection apparatus, the first tube and the second tube may not overlap the region. According to the configuration, the possibility that the end effector interferes with the tubes can be further reduced.

4. In the configuration described above, the end effector may include a suction unit that suctions the molded product and a pipe coupled to the suction unit, and the pipe may be disposed along a direction in which the end effector is inserted between the fixed-side plate and the movable-side plate. According to the configuration, the possibility that the end effector interferes with the first tube and the second tube can be reduced.

5. In the configuration described above, the injection molding apparatus may be operated in a production mode selected from a first production mode, a second production mode, and a third production mode, the first production mode may be a mode in which the operator ejects the molded product at the work position without operating the ejection apparatus, the second production mode may be a mode in which the ejection apparatus delivers the ejected molded product to a downstream process line, and the third production mode may be a mode in which the ejection apparatus puts the ejected molded product in a carry-out tray. According to the configuration, the injection molding system can be applied to various production sites.

What is claimed is:

1. An injection molding system comprising:
an injection molding apparatus to which a mold is attached; and
an ejection apparatus that ejects a molded product from the mold in a mold open state in which the mold is open, wherein
the injection molding apparatus is configured to enable an operator to eject the molded product from the mold at a predetermined work position, and
the injection molding apparatus is disposed between the work position and the ejection apparatus.

2. The injection molding system according to claim 1, wherein
the mold includes a fixed-side plate and a movable-side plate,
the mold open state is a state in which the movable-side plate is separated from the fixed-side plate,
a first tube that supplies a fluid into the fixed-side plate is coupled to the fixed-side plate,
a second tube that supplies a fluid into the movable-side plate is coupled to the movable-side plate,
the ejection apparatus includes an end effector inserted between the fixed-side plate and the movable-side plate in the mold open state,
the first tube is coupled to the fixed-side plate to prevent the end effector from interfering with the first tube in the mold open state, and
the second tube is coupled to the movable-side plate to prevent the end effector from interfering with the second tube in the mold open state.

3. The injection molding system according to claim 2, wherein
when a region between the fixed-side plate and the movable-side plate in the mold open state is viewed from a side of the ejection apparatus, the first tube and the second tube do not overlap the region.

4. The injection molding system according to claim 2, wherein
the end effector includes a suction unit that suctions the molded product and a pipe coupled to the suction unit, and
the pipe is disposed along a direction in which the end effector is inserted between the fixed-side plate and the movable-side plate.

5. The injection molding system according to claim 1, wherein
the injection molding apparatus is operated in a production mode selected from a first production mode, a second production mode, and a third production mode,
the first production mode is a mode in which the operator ejects the molded product at the work position without operating the ejection apparatus,
the second production mode is a mode in which the ejection apparatus delivers the ejected molded product to a downstream process line, and
the third production mode is a mode in which the ejection apparatus puts the ejected molded product in a carry-out tray.
